(19) United States
(12) Patent Application Publication
(10) Pub. No.: US 2007/0250184 A1
(43) Pub. Date: Oct. 25, 2007

(54) Optimizing Control Method and System, Overall Control Apparatus and Local Control Apparatus

(76) Inventors: Hiroshi Arita, Hitachi (JP); Yasuhiro Nakatsuka, Naka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/737,850

(22) Filed: Apr. 20, 2007

(30) Foreign Application Priority Data
Apr. 20, 2006 (JP) 2006-116305

(51) Int. Cl. G05B 13/02

(52) U.S. Cl. 700/28

(57) ABSTRACT

An optimizing control system includes at least a local control unit for controlling at least a control apparatus, an integration control apparatus for controlling a plurality of the local control units in integration fashion, and at least a control information standardization interface arranged between the local control unit and the integration control apparatus for standardizing the control information transmitted and received between the local control unit 31 and the integration control apparatus. The control information standardization interface includes a control condition information storage unit for storing the constraints, the evaluation function and the attribute information expressed by a predetermined standard physical quantity for controlling the local apparatus, and a physical quantity converter for converting the local physical status amount acquired from the local apparatus into a standard physical status amount and converting the optical setpoint calculated by the integration control apparatus into a local control goal value.

### BACKGROUND OF THE INVENTION

This invention relates to an optimizing control method, an optimizing control system, an integration control apparatus and a local control apparatus for optimally controlling a plurality of apparatuses for the same purpose in integration fashion.

It is now of an urgent necessity to tackle the problem of the reduction in CO₂ emission to prevent the global warming over the whole world. In view of this, various technological development efforts are going on to improve the energy use efficiency by reducing the wasteful energy consumption in all fields including factories (including plants), office buildings, public facilities/buildings, automotive vehicles and homes in general. In automotive vehicles and railway vehicles, for example, the reuse of energy has been made possible by use of a regeneration brake and the use of clean energy such as the solar power is being developed in ordinary homes.

In the case where a multiplicity of energy-related control apparatuses are installed in a factory or a large-scale facility, these control apparatuses are required to be controlled in integration fashion to minimize the energy consumption of the factory or the facility as a whole. In a control system, local conditions can be generally optimized by individual control apparatuses, the whole system cannot be optimized simply by accumulating the local optimization conditions in the presence of a tradeoff between the control parameters output from individual control apparatuses.

The system control method now most widely used is the loop control scheme for controlling one parameter toward one control goal value. With the design theory thereof established, this control method is high in safety and maintainability. On the other hand, the model control scheme is available as a control method capable of identifying a plurality of control parameters. The model control scheme, however, requires the development of a particular model for each control system, and with the increased scale and the resulting complication of the control system, requires a great amount of time and labor for development. Currently, therefore, the model control scheme is used only for a control system in such a limited field of application as a chemical plant.

JP-A-2004-17153 discloses an example of the control system in which the model control scheme capable of identifying a plurality of control parameters is combined with the loop control scheme capable of stable control of one control parameter, thereby taking advantage of the features of each control method. In this control system, the optimizing control theory is used for the model control scheme, and based on the evaluation function and the constraints set in advance, the control parameters for a plurality of loop control scheme are identified. Specifically, the model control scheme and the loop control scheme are combined seamlessly, and a cost-minimum energy-saving control system is realized. Incidentally, textbooks of the optimizing control theory are many including Yamaura: “Introduction to Optimizing Control”, published by Corona, January 1996.

In the control system disclosed in Patent Document 1, however, the model control scheme is used, and therefore, the problem of the prior art that a great amount of time and labor is required for model development of the control system has yet to be solved. Also, in the model development, even similar control systems require the individual development of different models in the case where the evaluation function or the constraints for optimization or the system status variables are different. Further, even after a model has been developed, a new independent model is often required to be developed in the case where the configuration of the control system undergoes a change.

Taking the current global environment problem into consideration, the development of various energy-saving systems is expected to come to be required in the future, and the aforementioned problem of the model control scheme, however, hampers the development of the energy-saving systems. Especially, in the control system for ordinary homes and automotive vehicles which are short in product life and whose configuration often undergoes a change, the development and application of the optimizing control system by the model control scheme cannot be considered to have a practical value.

### SUMMARY OF THE INVENTION

In view of the problems of the prior art described above, the object of this invention is to provide an optimizing control method, an optimizing control system, an integration control apparatus and a local control apparatus capable of optimizing a plurality of control parameters and reducing the time and labor required to construct the control system.

In order to achieve the aforementioned object, according to this invention, there is provided an optimizing control system comprising at least a local control apparatus connected to a local apparatus for controlling the local apparatus, an integration control apparatus connected to a plurality of local control apparatuses for controlling the plurality of the local control apparatuses in integration fashion, and a plurality of control information standardization interfaces arranged between each of the local control apparatuses and the integration control apparatus for standardizing the control information transmitted and received between the particular local control apparatus and the integration control apparatus, wherein the control information standardizing interfaces and the integration control apparatus of the optimizing control system are operated according to the following steps in which:

(1) Each control information standardization interface holds the control condition information including the constraints and the evaluation function expressed by a predetermined standard physical quantity for controlling the corresponding local apparatus and the attribute information indicating the feature of the control operation of the local apparatus, and converts the local physical status amount output from the local control apparatus into a standard physical status amount expressed by a predetermined physical standard amount;

(2) The integration control apparatus calculates the optical setpoint for each local control apparatus based on the control condition information held by each control information standardization interface and the converted standard physical status amount; and

(3) The control information standardization interface converts the optical setpoint calculated by the integration control apparatus for each local control apparatus into the local control goal value of the physical quantity corresponding to each local apparatus, and outputs the converted local control goal value to the local control apparatus.

According to this invention, the integration control apparatus and the plurality of the local control apparatuses are connected to each other through a plurality of control information standardization interfaces corresponding to the respective local control apparatuses. The integration control apparatus, therefore, can obtain the physical status amounts of the local apparatuses output from various local control apparatuses in the form of a standard physical status amount expressed by the standard physical quantities regardless of the difference among the local control apparatuses. Also, the constraints and the evaluation function for each local control apparatus can be expressed by the corresponding standard physical quantity, and therefore, the integration control apparatus can easily generate an integrated constraints and an integration evaluation function combining the constraints and the evaluation functions of the local control apparatuses. As a result, the control goal values for the plurality of the local control apparatuses can be easily calculated as an optical setpoint indicated by the standard physical quantity.

Each control information standardization interface has stored therein the constraints and the evaluation function indicated by the standard physical quantity for controlling the local apparatus controlled by the local control apparatus. Even in the case where a new local control apparatus is added to the integration control apparatus, therefore, the integration control apparatus can easily generate the integrated constraints and the integration evaluation function by acquiring the constraints and the evaluation function from the control information standardization interface. Also, even in the case where the local control apparatus connected to the integration control apparatus is disconnected, the constraints and the evaluation function for the local control apparatus can be easily deleted from the integrated constraints and the integration evaluation function.

Specifically, according to this invention, the local control apparatus can be easily added to or deleted from the integration control apparatus. In other words, as long as the control information standardization interface is prepared for the local control apparatus, the optimizing control system can be easily constructed using the particular local control apparatus. As a result, an optimizing control system capable of optimizing a plurality of control parameters can easily constructed, and the time and labor required for the construction thereof can be reduced.

According to this invention, the optimizing control system capable of optimizing a plurality of control parameters can be easily constructed, and the time and labor required for the construction can be reduced.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an example of the configuration of an optimizing control system according to a first embodiment of the invention.

FIG. 2 is a diagram showing an example of the configuration of an optimizing control system according to a second embodiment of the invention.

FIG. 3 is a diagram showing an example of the configuration of an optimizing control system according to a third embodiment of the invention.

FIG. 4 is a diagram showing an example of the configuration of an optimizing control system according to a fourth embodiment of the invention.

FIG. 5 is a diagram showing an example of the process flow with a new local control apparatus connected to the integration control apparatus according to the fourth embodiment of the invention.

FIG. 6 is a diagram showing a specific example of the energy optimizing control system used for the trailer.

FIG. 7 is a diagram showing a second specific example of the energy optimizing control system used for the trailer.

FIG. 8 is a diagram showing a specific example of the energy optimizing control system used for the passenger car.

FIG. 9 is a diagram showing a specific example of the energy optimizing control system used for an ordinary house.

### DETAILED DESCRIPTION OF THE INVENTION

Embodiments of the invention are explained in detail below with reference to the accompanying drawings.

### First Embodiment

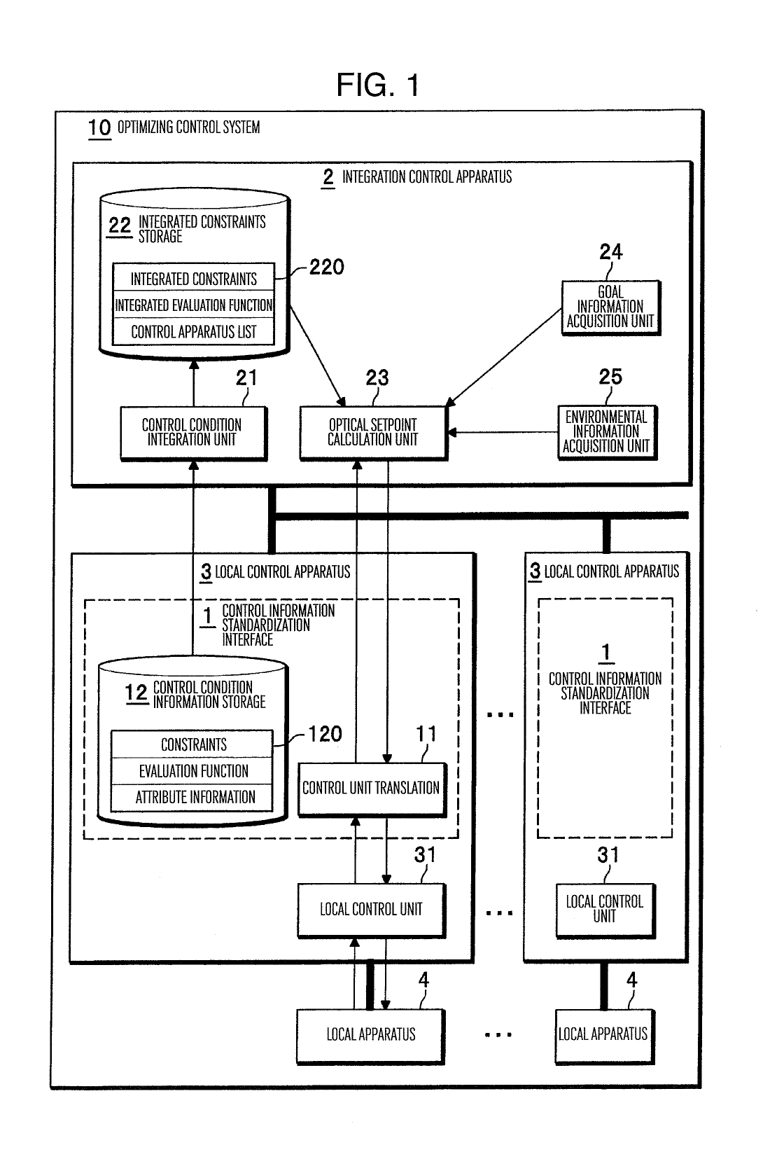

FIG. 1 is a diagram showing an example of the configuration of the optimizing control system according to a first embodiment of the invention. As shown in FIG. 1, the optimizing control system 10 according to this embodiment includes a plurality of local control apparatuses each connected to a local apparatus 4 for controlling the particular local apparatus 4 and an integration control apparatus 2 connected to a plurality of the local control apparatuses 2 to control the plurality of the local control apparatuses 3 in integration fashion.

In FIG. 1, each local control apparatus 3 includes a local control apparatus 31 for controlling the local apparatus 4 individually and a control information standardization interface 1 arranged between a local control unit 31 and the integration control apparatus 2 for standardizing the control information transmitted and received between the local control unit 31 and the integration control apparatus 2. Also, each control information standardization interface 1 includes a physical quantity converter 11 and a control condition information storage unit 12.

The physical quantity converter 11 converts the local physical status amount output from the corresponding local apparatus 4 into a standard physical status amount expressed by a predetermined standard physical quantity (such as an energy value), and outputs the converted standard physical status amount to the integration control apparatus 2. On the other hand, the optical setpoint expressed by the standard physical quantity output from the integration control apparatus 2 is converted to a local control goal value of the physical quantity corresponding to the control situation of the local apparatus 4.

The control condition information storage unit 12 stores the control condition information 120 for controlling the local apparatuses 4. The control condition information 120 includes the constraints and the evaluation function for controlling the local apparatuses 4 expressed by the standard physical quantity and the attribute information indicating the control features of the local apparatuses 4.

Each local control apparatus 3 includes a CPU (Central Processing Unit) and a storage unit such as a semiconductor memory or a hard disk unit. The functions of the physical quantity converter 11 are realized by the CPU executing the physical quantity conversion program stored in the storage unit of the CPU. Also, each control condition information storage unit 12 is implemented by a storage region of a predetermined size secured for the particular storage unit, and the control condition information 120 for controlling the local apparatuses 4 is stored in the particular storage region.

Next, in FIG. 1, the integration control apparatus 2 includes a control condition integration unit 21, an integrated constraints storage unit 22, an optical setpoint calculation unit 23, a goal information acquisition unit 24 and an environmental information acquisition unit 25.

The control condition integration unit 21 acquires the control condition information 20 stored in the control condition information storage unit 12 of the control information standardization interface 1 of each local control apparatus 3 connected to the integration control apparatus 2, and by integrating the constraints and the evaluation functions included in the acquired control condition information 120, generates an integrated constraints and an integration evaluation function expressed by the standard physical quantity. The integrated constraints and the integration evaluation function thus generated are stored as the integration control condition information 220 in the integrated constraints storage unit 22.

The integrated constraints storage unit 22 stores the integration control condition information 220. The integration control condition information 220, in addition to the integrated constraints and the integration evaluation function generated by the control condition integration unit 21, includes the attribute information of each local control apparatus 3 and a control apparatus list including the correspondence between the constraints and the evaluation function for the control operation by the particular local control apparatus 3.

The goal information acquisition unit 24 includes an input device connected to the integration control apparatus 2 and acquires the goal information input by the user of the optimizing control system 10 having a certain intention. In the case of the optimizing control system 10 used for the energy saving system of automotive vehicles, for example, the goal information acquisition unit 24 acquires signals from the brake and the accelerator.

The environmental information acquisition unit 25 includes an input device such as a sensor connected to the integration control apparatus 2, and acquires the information on the environment surrounding the optimizing control system 10. In the case of the optimizing control system 10 used for the energy saving system of automotive vehicles, for example, the environmental information acquisition unit 25 acquires the atmospheric temperature around the vehicles and the information on the road gradient.

The optical setpoint calculation unit 23 calculates the optical setpoint expressed by the standard physical quantity for each of the local control apparatuses 3 using the integrated constraints and the integration evaluation function stored in the integrated constraints storage unit 22, the standard physical status amount output from the physical quantity converter 11 of each local control apparatus 3, the environmental information acquired by the environmental information acquisition unit 25 and the goal information acquired by the goal information acquisition unit 24.

The integration control apparatus 2 is an information processing unit including a CPU and a storage unit such as a semiconductor memory or a hard disk unit. The functions of the control condition integration unit 21 and the optical setpoint calculation unit 23 are realized by the CPU executing the control condition information integrating program and the optical setpoint calculation program stored in the storage unit of the CPU. Also, the integrated constraints storage unit 22 is implemented by the storage region of a predetermined size secured in the storage unit, and the integration control condition information 220 is stored in the particular storage region.

The integration control apparatus 2 and the local control apparatuses 3 are connected to each other through a network such as LAN (Local Area Network) or CAN (Controller Area Network). The local control apparatus 3 and the corresponding local apparatus 4, on the other hand, may be connected to each other by an interface signal corresponding to the situation of the local apparatus 4.

Next, the optimizing control method according to this embodiment, i.e. the method of calculating the optical setpoint in the optical setpoint calculation unit 23 is explained.

First, assume that the integration control apparatus 2 is connected to p objects to be controlled (hereinafter referred to simply as the objects), i.e. p local control apparatuses 3. Under this condition, the optical setpoint calculation unit 23 is supplied with m standard physical status amounts from the physical quantity converter 11 of the k-th local control apparatus 3 and outputs n optical setpoints to the physical quantity converter 11. Such amounts and values are expressed by the vector Yₖ(t) and the vector Xₖ(t), respectively. In other words, the optical setpoint vector Xₖ(t) and the standard physical status amount vector Yₖ(t) are expressed by Equation (1) and Equation (2), respectively.
Xₖ(t)=(x_{k,1}(t), x_{k,2}(t), . . . , x_{k,n}(t)) (1)
Yₖ(t)=(y_{k,1}(t), y_{k,2}(t), . . . , y_{k,m}(t)) (2)

In these equations, the vector components x_{k,1}(t), x_{k,2}(t), . . . , x_{k,n}(t) represent the n optical setpoints output by the optical setpoint calculation unit 23 toward the k-th local control apparatus 3, and y_{k,1}(t), y_{k,2}(t), . . . , y_{k,m}(t) represent the m standard physical status amounts acquired by the optical setpoint calculation unit 23 from the k-th local control apparatus 3. Incidentally, k=1, . . . , p, and (t) indicates the function of time.

Then, the constraints for controlling the local apparatus 4 of the k-th local control apparatus 3 is expressed by Equation (3) and the associated evaluation function by Equation (4).
h_{k,i}(t,Xₖ(t),Yₖ(t))≦c_{k,i} (3)
gₖ(t,Xₖ(t),Yₖ(t)) (4)

In these equations, k=1, . . . , p, and i=1, . . . , q. The character q designates the number of the constraints. Specifically, a plurality of the constraints may exist for one control object, i.e. one local control apparatus 3. Also, character c_{k,j} designates a constant, which may be a simple constant 0 or a critical value of the constraints. In Equation (3) of the constraints, the left and right sides are connected by an inequality sign and may alternatively be connected by the equality sign.

Also, Equation (3) of the constraints and Equation (4) of the evaluation function are both the function of time t, the optical setpoint vector Xₖ(t) and the standard physical status amount vector Yₖ(t). Further, both Equation (3) of the constraints and Equation (4) of the evaluation function may be the function including the time derivation of the optical setpoint vector Xₖ(t) and the standard physical status amount vector Yₖ(t).

Equation (3) of the constraints and Equation (4) of the evaluation function are normally developed to construct a control system in which the local apparatus 4 is controlled by the local control apparatus 3, and are held as the control condition information 120 in the control condition information storage unit 12. In the process, the conversion equation of the physical quantity for the physical quantity converter 11 is determined.

The integration control apparatus 2, through the control condition integration unit 21, acquires the control condition information 120 stored in each control condition information storage unit 12 of each local control apparatus 3 connected to the integration control apparatus 2, and by integrating the constraints and the evaluation function included in each control condition information 120, generates the integrated constraints and the integration evaluation function.

In integrating the constraints, the control condition integration unit 21 classifies the constraints obtained from the local control apparatus 3 according to the attribute information indicating what is represented by the value of the equation of the constraints. The attribute information is stored beforehand with the corresponding equation of each constraints, for example, as the attribute information of the control condition information 120. The constraints of the same attribute information obtained from different local control apparatuses 3 are integration into one equation according to the physical law such as the energy conservation law or the momentum conservation law. In the process of integration, the environmental information vector S(t) is taken into consideration, if required. The constraints lacking the same attribute information are not integration, and the constraints expressed by Equation (3) is used as it is as an integrated constraints.

Equation (5) generally expresses the integrated constraints integration by the control condition integration unit 21.
Hᵢ(t,X₁(t), . . . , Xₚ(t), Y₁(t), . . . , Yₚ(t), S(t))≦Cᵢ (5)

In this equation, S(t) is the environmental information vector having s components. Specifically, each component is a value of the environmental information acquired by the environmental information acquisition unit 25. This value of the environmental information is also expressed by the value converted into the standard physical quantity.

In Equation (5), i=1, . . . , Q, where Q is the number of the integrated constraints. Also, Ci is a constant, which may be a simple constant 0 or may express the critical value of the constraints.

Next, the integration evaluation function can be expressed, as shown by Equation (6) for example, as a weighted average of the evaluation functions gₖ of the local control apparatus 3.

$$J = {\sum }_{k = 1}^{P} {a}_{k} {g}_{k} ( t , {X}_{k} ( t ) , {Y}_{k} ( t ) ) \qquad ( 6 )$$

In this equation, aₖ is the weighted value of the weighted average and satisfies the relation a₁+a₂+ . . . +aₚ=1. Incidentally, the weighted value aₖ is not always constant, but may be appropriately changed in accordance with the input information from the goal information acquisition unit 24.

As described above, once Equation (5) of the integrated constraints and Equation (6) of the integration evaluation function J are prepared by the control condition integration unit 21, the optical setpoint calculation unit 23 calculates the optical setpoint vector Xₖ(t) (k=1, . . . , p) satisfying Equation (5) of the integrated constraints and maximizing (minimizing) Equation (6) of the integration evaluation function J. In calculating the optical setpoint vector Xₖ(t), the numerical calculation method such as the well known steepest gradient method (hill-climbing method) can be used.

The optical setpoint calculation unit 23, upon calculation of the optical setpoint vector Xₖ(t) as described above, outputs the value of each component of the calculated optical setpoint vector Xₖ(t) as the optical setpoint of the k-th local control apparatus 3.

Incidentally, in place of Equation (6), Equation (7) below may be used to calculate the integration evaluation function J.

$$J = {\sum }_{k = 1}^{P} {\int }_{{t}_{1}}^{{t}_{2}} {a}_{k} {g}_{k} ( t , {X}_{k} ( t ) , {Y}_{k} ( t ) ) ⅆ t \qquad ( 7 )$$

In this equation, t₁ may designate the present time and t₂ the subsequent time. In such a case, the optimizing control operation predicting the future situation is made possible.

According to this embodiment, as described above, the local control apparatus 3 includes the physical quantity converter 11, through which the control information (the standard physical status amount and the optical setpoint) converted into a predetermined physical quantity (such as an energy value) are transmitted to or received from the integration control apparatus 2. Also, in the local control apparatus 3, regardless of the loop control scheme or the model control scheme, the constraints and the evaluation function for controlling the local apparatuses 4 can be expressed by the standard physical quantity and stored in the control condition information storage unit 12.

Therefore, the integration control apparatus 2, regardless of what kind of the local control apparatus 3 is connected thereto, can transmit and receive information to and from the particular local control apparatus 3 using the control information converted into the standard physical quantity. Also, the integration control apparatus 2 can acquire, from the local control apparatuses 3 connected thereto, the constraints and the evaluation functions for the controlling the local apparatuses 4 controlled by the local control apparatuses 3. The constraints and the evaluation function are expressed by the standard physical quantity, and therefore, regardless of what kind of local control apparatus 3 is connected thereto, the integration control apparatus 2, by acquiring the constraints and the evaluation functions from the local control apparatuses 3, can easily generate the integrated constraints and the integration evaluation function as an integration of the constraints and the evaluation functions. Based on the integrated constraints and the integration evaluation function, the integration control apparatus 2 can provide the optical setpoint most suitable for each local control apparatus 3.

Specifically, in the optimizing control system 10 according to this embodiment, the control system developer can develop the constraints and the evaluation function expressed by the standard physical quantity for the control system of the local apparatus 4 mainly in the local control apparatus 3 without substantially taking the control structure of the optimizing control system 10 as a whole into consideration. As a result, the labor and time required for development of the whole optimizing control system 10 are remarkably reduced as compared with the prior art.

### Second Embodiment

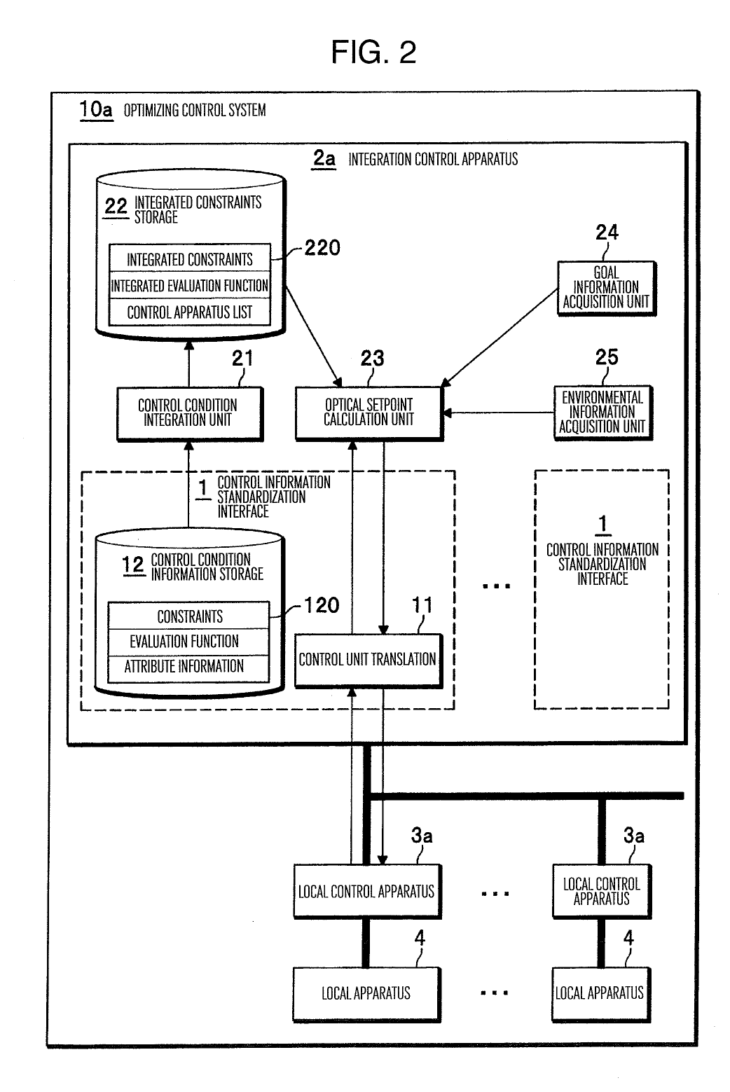

FIG. 2 is a diagram showing an example of the configuration of the optimizing control system according to a second embodiment of the invention. As shown in FIG. 2, the optimizing control system 10a according to the second embodiment includes local control apparatuses 3a each connected to a local apparatus 4 for controlling the same local apparatus 4, and an integration control apparatus 2a connected to a plurality of the local control apparatuses 3a to control the plurality of the local control apparatuses 3a in integration fashion. In FIG. 2, the component elements having the same functions as those in FIG. 1 are designated by the same reference numerals, respectively.

In the optimizing control system 10a according to the second embodiment is different from the optimizing control system 10 according to the first embodiment (FIG. 1) in that in the second embodiment, each control information standardization interface 1 is included not in the local control apparatus 3a but in the integration control apparatus 2a.

Each local control apparatus 3a outputs the local physical status amount expressed by the physical quantity corresponding to the situation of the local apparatus 4 or the local control apparatus 3a to the integration control apparatus 2a on the one hand, and receives the local control goal value expressed by the physical quantity corresponding to the situation of the local apparatus 4 or the local control apparatus 3a from the integration control apparatus 2a thereby to control the local apparatus 4.

The integration control apparatus 2a, in addition to the component elements of the integration control apparatus 2 according to the first embodiment, includes a control information standardization interfaces 1 corresponding to the respective local control apparatuses 3a connected to the integration control apparatus 2a. Each control information standardization interface 1 includes a physical quantity converter 11 and a control condition information storage unit 12 for storing the control condition information 120. The physical quantity converter 11 converts the local physical status amount output from the local control apparatus 3a into a standard physical status amount expressed by a predetermined physical quantity on the one hand and converts the optical setpoint output from the optical setpoint calculation unit 23 into the local control goal value corresponding to the situation of the local control apparatus 3a or the local apparatus 4 on the other hand. Also, the control condition information 120 includes the constraints and the evaluation function for controlling the local apparatus 4 in terms of the standard physical quantity and the attribute information indicating the features of the control operation of the local apparatus 4.

As described above, according to the second embodiment, the functions and the operation of the control information standardization interfaces 1 are identical with those of the first embodiment except that the control information standardization interfaces 1 are included not in the local control apparatus 3a but in the integration control apparatus 2a. Also, the functions and operation of the integration control apparatus 2a are identical with those of the integration control apparatus 2 according to the first embodiment except that the integration control apparatus 2a includes the control information standardization interfaces 1. The optimizing control system 10a according to the second embodiment, therefore, has substantially the same operation and effects as the optimizing control system 10 according to the first embodiment.

In the second embodiment, the developer of the control system is required to develop, for each local control apparatus 3a connected to the integration control apparatus 2a, the physical quantity converter 11 for converting the local physical status amount and the local control goal value transmitted to and received from the integration control apparatus 2a by the particular local control apparatus 3a, into the standard physical status amount and the optical setpoint expressed by the standard physical quantity, and incorporate the particular physical quantity converter 11 into the integration control apparatus 2a.

Further, the developer of the control system is required to express, by the standard physical quantity, the constraints and the evaluation function for controlling each local apparatus 4 controlled by the local control apparatus 3a, and by determining the attribute information indicating the features of the control operation of the particular local apparatus 4, to store the attribute information in the control condition information storage unit 12 as the control condition information 120.

### Third Embodiment

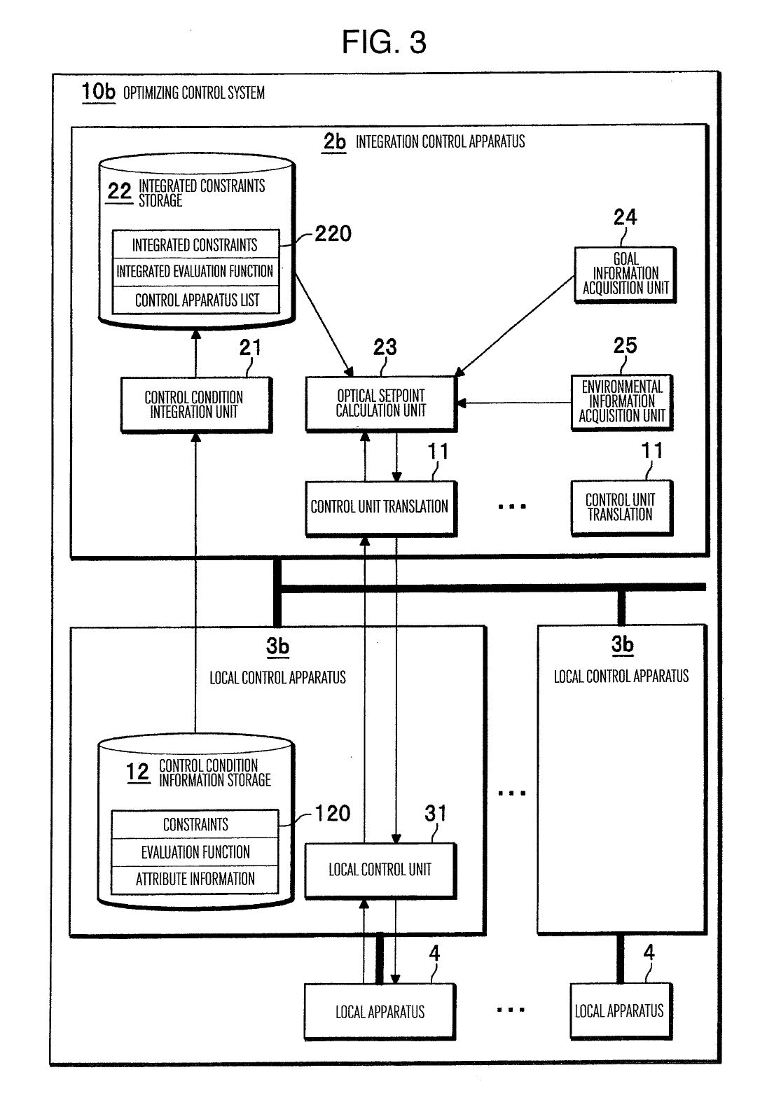

FIG. 3 is a diagram showing an example of the configuration of the optimizing control system according to a third embodiment of the invention. As shown in FIG. 3, the optimizing control system 10b according to the third embodiment includes a plurality of local control apparatuses 3b connected to the local apparatuses 4 to control the local apparatuses 4, and an integration control apparatus 2b connected to a plurality of the local control apparatuses 3b to control the plurality of the local control apparatuses 3b in integration fashion. In FIG. 3, the component elements having the same functions as those in FIG. 1 are designated by the same reference numerals, respectively.

The optimizing control system 10b according to the third embodiment is different from the optimizing control system 10 (FIG. 1) according to the first embodiment in that in the optimizing control system 10b, the physical quantity converter 11 is included not in each local control apparatus 3b but in the integration control apparatus 2b.

The local control apparatus 3b includes a local control unit 31 and a control condition information storage unit 12. The local control unit 31 outputs the local physical status amount expressed by the physical quantity corresponding to the situation of the local apparatus 4 or the local control unit 31 to the integration control apparatus 2b on the one hand and receives the local control goal value expressed by the physical quantity corresponding to the situation of the local apparatus 4 or the local control unit 31 from the integration control apparatus 2b thereby to control the local apparatus 4 on the other hand.

The control condition information storage unit 12 stores the control condition information 120, which includes the constraints and the evaluation function for controlling the local apparatus 4 expressed by a predetermined physical quantity and the attribute information indicating the features of the control operation of the local apparatus 4.

The integration control apparatus 2b, in addition to the component elements of the integration control apparatus 2 according to the first embodiment, includes the physical quantity converter 11 corresponding to each of the local control apparatuses 3b connected to the integration control apparatus 2b. The physical quantity converter 11 converts the local physical status amount output from the local control unit 31 into the standard physical status amount expressed by a predetermined physical quantity on the one hand and converts the optical setpoint output from the optical setpoint calculation unit 23 into a local control goal value corresponding to the situation of the local control unit 31 or the local apparatus 4 on the other hand.

As described above, according to the third embodiment, the functions and the operation of the local control apparatus 3b are identical with those of the local control apparatus 3 according to the first embodiment except that the local control apparatus 3b according to the third embodiment has no physical quantity converter 11. The functions and the operation of the integration control apparatus 2b, on the other hand, are identical with those of the integration control apparatus 2 according to the first embodiment except that the integration control apparatus 2b includes the physical quantity converter 11. The optimizing control system 10b according to the third embodiment, therefore, has substantially the same operation and effects as the optimizing control system 10 according to the first embodiment.

### Fourth Embodiment

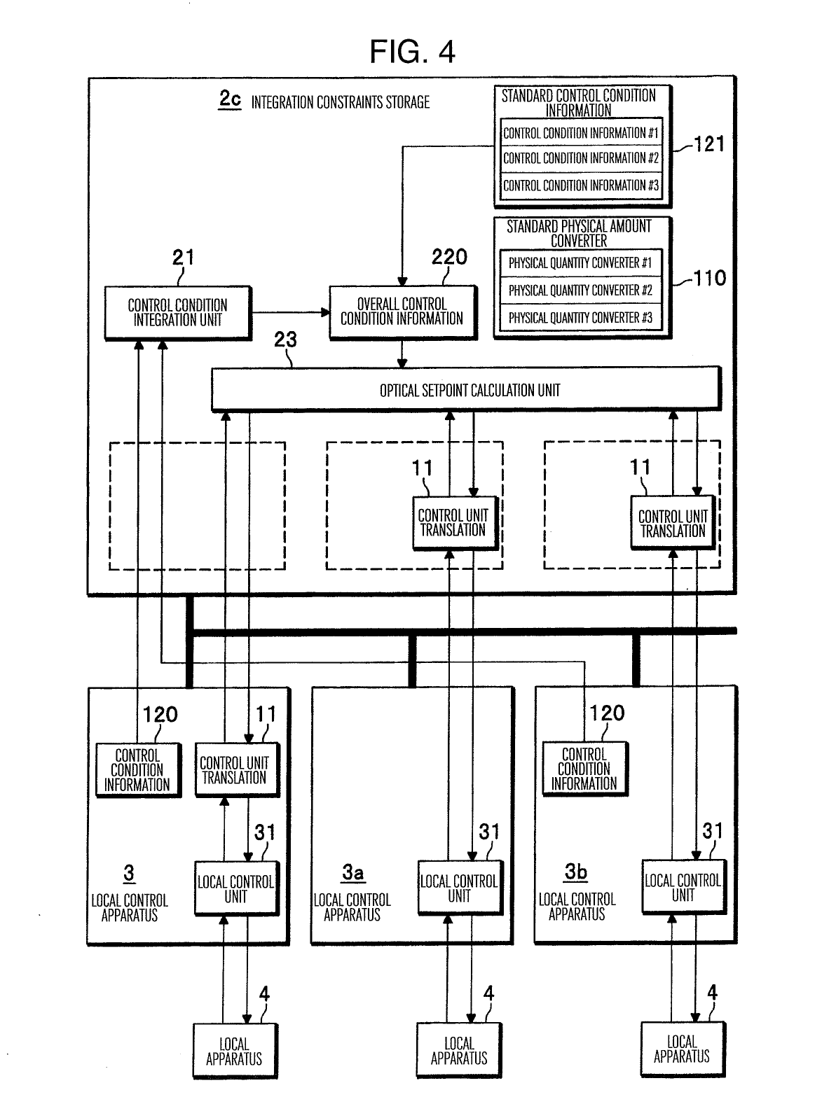

FIG. 4 is a diagram showing an example of the configuration of the optimizing control system according to a fourth embodiment of the invention. The optimizing control system according to the fourth embodiment includes local control apparatuses 3, 3a, 3b connected to the respective local apparatuses 4 to control the particular local apparatuses 4 and an integration control apparatus 2c connected to the local control apparatuses 3, 3a, 3b to control the local control apparatuses 3, 3a, 3b in integration fashion. Specifically, the integration control apparatus 2c according to this embodiment can control the local control apparatuses 3, 3a, 3b according to the first to third embodiments combined.

In FIG. 4, the component elements having the same functions as those in FIGS. 1 to 3 are designated by the same reference numerals, respectively. In FIG. 4, to avoid complication, the control condition information storage unit 12 and the integrated constraints storage unit 22 are not shown but the control condition information 120 and the integration control condition information 220 stored therein, respectively. Although the local control apparatuses 3, 3a, 3b are shown one each in FIG. 4, the number of each local control apparatus is not limited to one and may be plural.

According to this embodiment, the local control apparatus 3a has neither the control condition information 120 nor the physical quantity converter 11. Also, the local control apparatus 3b has no physical quantity converter 11. In view of this, the developer of the control system prepares the control condition information (control condition information #1 to #3, for example) adapted for the local control apparatus 3a, and stores it in the storage unit of the integration control apparatus 2c as standard control condition information 121.

In similar fashion, the developer of the control system prepares the program for implementing the physical quantity converters (physical quantity converters #1 to #3, for example) adapted for the local control apparatuses 3a, 3b, and stores them in the storage unit of the integration control apparatus 2c as standard physical quantity converter 110.

As described above, the integration control apparatus 2c, when integrating the control condition information 120 for the local control apparatuses 3, 3a, 3b connected thereto by the control condition integration unit 21, can retrieve and utilize the control condition information (the control condition information #1, for example) adapted for the local control apparatus 3a having no control condition information 120 from the standard control condition information 121. Similarly, with regard to the local control apparatuses 3a, 3b having no physical quantity converter 11, the integration control apparatus 2c can retrieve the physical quantity converters (physical quantity converters #1, #2, for example) adapted for the local control apparatuses 3a, 3b and set the retrieved physical quantity converters (physical quantity converter #1, #2, for example) as the physical quantity converter 11 actually executing the physical conversion, thereby making possible each physical conversion.

This embodiment produces a new effect that the local control apparatuses 3, 3a, 3b can be very easily connected to or removed from the integration control apparatus 2c.

Specifically, the control condition information #1 to #3, for example, adapted for a specific local control apparatus 3a which may be connected to the integration control apparatus 2c are stored beforehand in the storage apparatus as the standard control condition information 121. Also, the standard physical quantity converters #1 to #3, for example, adapted for specific local control apparatuses 3, 3a, 3b which may be connected to the integration control apparatus 2c are stored beforehand in the storage unit as the standard physical quantity converter 110.

Specifically, in the case where the integration control apparatus 2c already connected to some of the local control apparatuses 3, 3a, 3b and local control apparatus 3a is newly connected with integrated control apparatus 2c, then the integration control apparatus 2c can immediately generate a new integration control condition information 220 in such a manner that the control condition information 120 included in the local control apparatuses 3, 3b or the control condition information (the control condition information #1, for example) adapted for the local control apparatus 3a prepared in the standard control condition information 121, as the case may be, is integration with the existing integration control condition information 220 through the control condition integration unit 21.

Also, the integration control apparatus 2c, when the optical setpoint calculation unit 23 outputs the optical setpoint for the local control apparatuses 3, 3a, 3b based on the newly generated integration control condition information 220, can convert the physical quantity using the physical quantity converter 11 included in the local control apparatus 3 itself or the physical quantity converters (the physical quantity converters #1, #2, for example) adapted for the local control apparatuses 3a, 3b prepared in the standard physical quantity converter 110.

Also, in the case where one of the local control apparatus 3, 3a, 3b already connected to the integration control apparatus 2c is removed, the integration control apparatus 2c can immediately delete the control condition information for the local control apparatus 3 (or 3a, 3b) thus removed from the integration control condition information 220 and calculate the optical setpoint based on the new integration control condition information 220 by the optical setpoint calculation unit 23.

According to this embodiment, therefore, the local control apparatus 3 (or 3a, 3b) can be added or connected to or removed from the integration control apparatus 2c on line. In the resulting optimizing control system, therefore, the fail-safe characteristic against any fault of the local control apparatuses 3, 3a, 3b to be controlled can be secured while at the same time realizing the robust control.

According to this embodiment, the control system developer is required to prepare the standard control condition information 121 and the standard physical quantity converter 110 for specific local control apparatuses 3a, 3b. At the same time, the control condition information and the physical quantity converter for frequently-used or analogous local control apparatuses 3a, 3b can be standardized. Once the control condition information and the physical quantity converter can be standardized, therefore, the labor for developing the control condition information and the physical quantity converter for analogous local control apparatuses 3a, 3b subsequently developed can be remarkably reduced.

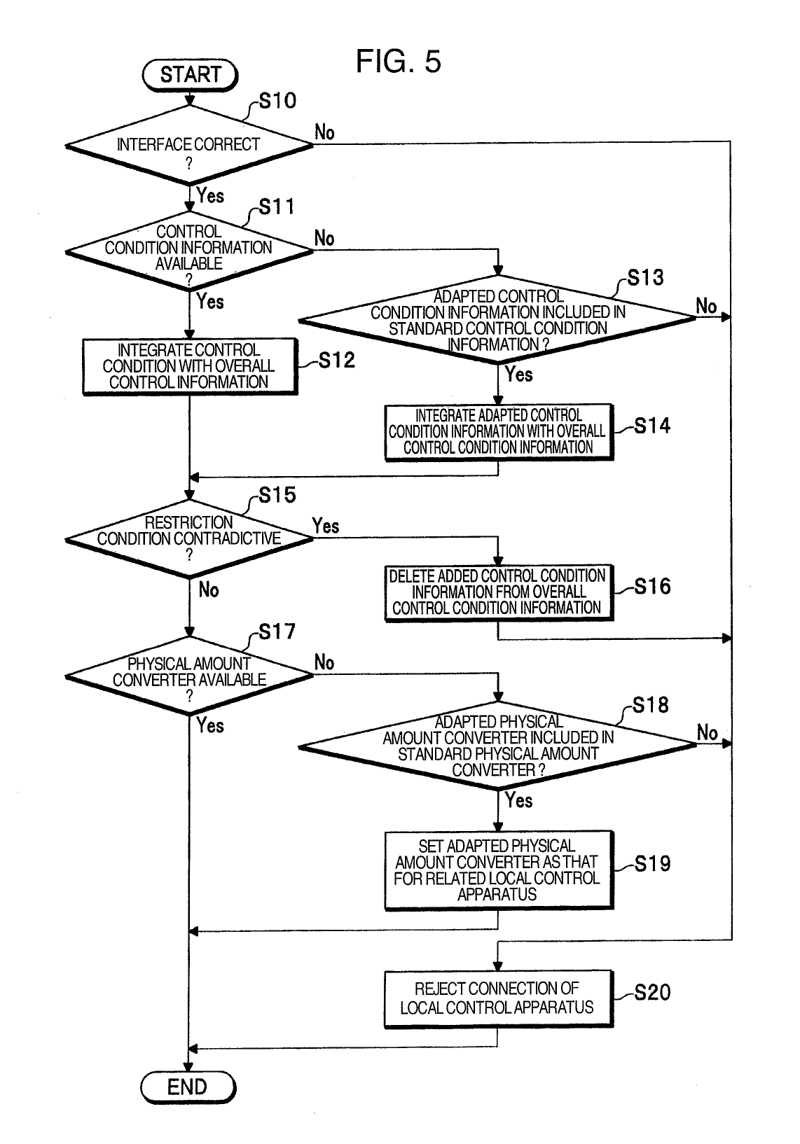

FIG. 5 is a diagram showing the flow of the process for adding and connecting a new local control apparatus to the integration control apparatus described above.

In FIG. 5, in the case where a new local control apparatus 3 (or 3a, 3b, hereinafter assumed to be included in 3) is added and connected to the integration control apparatus 2c, the integration control apparatus 2c first determines whether the interface of a particular local control apparatus 3 is correct or not, based on the information transmitted from the same local control apparatus 3 (step S10). Upon determination that the interface is not correct, i.e. in the case where the added local control apparatus 3 cannot be connected to the integration control apparatus 2c (NO in step S10), the integration control apparatus 2c rejects the connection of the particular local control apparatus 3 (step S20). In the process, the integration control apparatus 2c or the local control apparatus 3 displays a message or an alarm indicating the rejection of connection on an associated display unit (not shown).

Upon determination that the interface is correct (YES in step S10), on the other hand, the integration control apparatus 2c determines whether the local control apparatus 3 has the control condition information 120 or not (step S11). In the case where the local control apparatus 3 has the control condition information 120 (YES in step S11), the integration control apparatus 2c acquires the control condition information 20 from the local control apparatus 3 and integrates the control condition information 120 thus acquired with the integration control condition information 220 (step S12).

In the case where the local control apparatus 3 has no control condition information 120 (NO in step S11), the integration control apparatus 2c determines, with reference to the standard control condition information 121, whether the standard control condition information 121 includes the control condition information adapted for the added local control apparatus 3 (step S13). Upon determination that no adapted control condition information is available (NO in step S13), the integration control apparatus 2c rejects the connection of the particular local control apparatus 3 (step S20). In the case where the standard control condition information 121 contains the adapted control condition information contains the adapted control condition information (YES in step S13), on the other hand, the integration control apparatus 2c integrates the adapted control condition information with the integration control condition information 220 (step S14).

Immediately following step S12 or S14, the integration control apparatus 2c determines whether the constraints for the local control apparatus 3 added to the integration control condition of the integration control condition information 220 is contradictive with the constraints before addition (step S15). In the case where the constraints are contradictive with each other (YES in step S15), the integration control apparatus 2c deletes the control condition information added in step S12 or S14 from the integration control condition information 220 (step S16) and rejects the connection of the particular local control apparatus 3 (step S20).

In the case where the constraints are not contradictive with each other (NO in step S15), on the other hand, the integration control apparatus 2c further determines whether the local control apparatus 3 has the physical quantity converter 11 or not (step S17). Upon determination that the local control apparatus 3 has no physical quantity converter 11 (NO in step S17), the integration control apparatus 2c, with reference to the standard physical quantity converter 110, determines whether the standard physical quantity converter 110 has the physical quantity converter adapted for the local control apparatus 3 added (step S18). In the absence of the adapted physical quantity converter in the standard physical quantity converter 110 (NO in step S18), the integration control apparatus 2c rejects the connection of the particular local control apparatus (step S20).

In the case where the standard physical quantity converter 110 contains the adapted physical quantity converter (YES in step S18), on the other hand, the integration control apparatus 2c sets the particular adapted physical quantity converter as a physical quantity converter for the particular local control apparatus 3 (step S19), followed by finishing the process of FIG. 5. The process of step S19 is equivalent to the operation in which the local control apparatus 3 (corresponding to 3a, 3b in this case) has no physical quantity converter 11, the integration control apparatus 2c itself has made preparation for conversion of the physical quantity taking advantage of the adapted physical quantity converter prepared in the standard physical quantity converter 110.

Upon determination in step S17 that the local control apparatus 3 has the physical quantity converter 11 (YES in step S17), on the other hand, the process of FIG. 5 is ended immediately thereafter. In this case, the local control apparatus 3 can convert the physical quantity.

### SPECIFIC EXAMPLE OF OPTIMIZING CONTROL SYSTEM

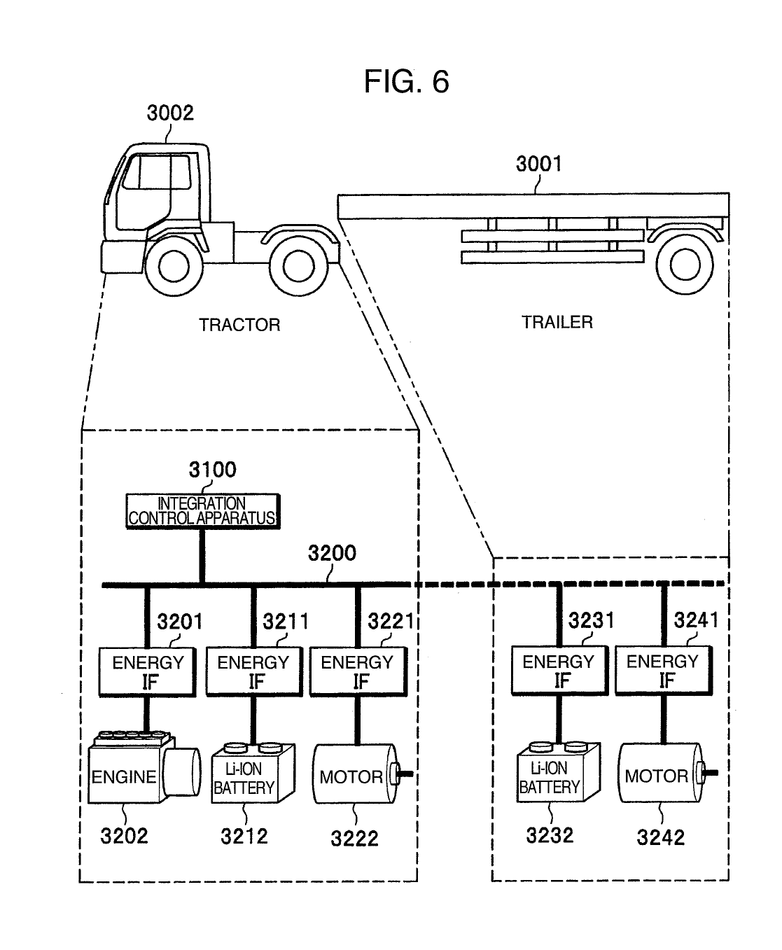

With reference to FIGS. 6 to 9, a specific example of the optimizing control system according to an embodiment of the invention is explained.

### Specific Example 1

FIG. 6 is a diagram showing a specific example of the energy optimizing control system used for the towed vehicle. As shown in FIG. 6, the towed vehicle is configured of a trailer 3001 constituting a carrier and a tractor 3002 having a tractor cab for towing the trailer 3001.

The tractor 3002 includes an integration control apparatus 3100 for the energy optimizing control operation, and the integration control apparatus 3100 is connected with, for example, an engine 3202, a Li (lithium) cell 3212 and a motor 3222 through energy IFs (interfaces) 3201, 3211, 3221, respectively, and a network 3200. Thus, this tractor 3002 is what is called a hybrid vehicle.

The energy IFs 3201, 3211, 3221 correspond to the control information standardization interfaces (FIG. 1) according to the first embodiment. In this specific example, energy is selected as a standard physical quantity, and therefore, the control information standardization interface 1 is called the energy IF (also the case with the specific examples described below). The energy IFs 3201, 3211, 3221 include the control condition information and the physical quantity converter for controlling the engine 3202, the Lead-acid battery 3212 and the motor 3222, respectively. Therefore, the integration control apparatus 3100 can generate the integrated constraints and the integration evaluation function for the energy optimizing control operation based on the control condition information.

While the tractor 3002 is running on its own, the integration control apparatus 3100 acquires a predetermined physical status amount from the engine 3202, the Lead-acid battery 3212 and the motor 3222 to be controlled on the one hand and calculates the energy goal value for optimizing control operation in accordance with a predetermined integration evaluation function and outputs the calculated energy goal value to the engine 3202, the Lead-acid battery 3212 and the motor 3222 on the other hand. In this way, the tractor 3002 realizes the energy optimizing control operation to save energy and reduce the CO₂ emission.

Once the trailer 3001 is coupled to the tractor 3002, the integration control apparatus 3100 is connected further with a Lead-acid battery 3232 and a motor 3242 through energy IFs 3231 and 3241, respectively. The integration control apparatus 3100, upon detection of connection of new objects to be controlled, acquires the control condition information from the energy IFs 3231, 3241, and generates the integrated constraints and the integration evaluation function optimally controllable by integrating the additionally connected Lead-acid battery 3232 and the motor 3242 in addition to the engine 3202, the Lead-acid battery 3212 and the motor 3222. Based on the integrated constraints and the integration evaluation function thus generated, the optimizing energy goal value is output for each of the engine 3202, the Lead-acid battery 3212, the motor 3222, the Lead-acid battery 3232 and the motor 3242.

Upon separation of the trailer 3001 from the tractor 3002, on the other hand, the integration control apparatus 3100 detects it, the energy optimizing control operation is performed only for the engine 3202, the Lead-acid battery 3212 and the motor 3222 on the tractor 3002.

As described above, in an application of the invention to the energy optimizing control system of a towed vehicle, the installation of the Lead-acid battery 3232 and the motor 3242 on the trailer 3001 makes it possible to easily construct the energy optimizing control system for the whole towed vehicle including the Lead-acid battery 3232 and the motor 3242 simply by coupling the trailer 3001 to the tractor 3002. In this energy optimizing control system, the torque can be strengthened due to the increased vehicle weight and the capacitance of the Lead-acid battery 3232 increased due to a larger regeneration power readily by connecting the trailer 3001.

### Specific Example 2

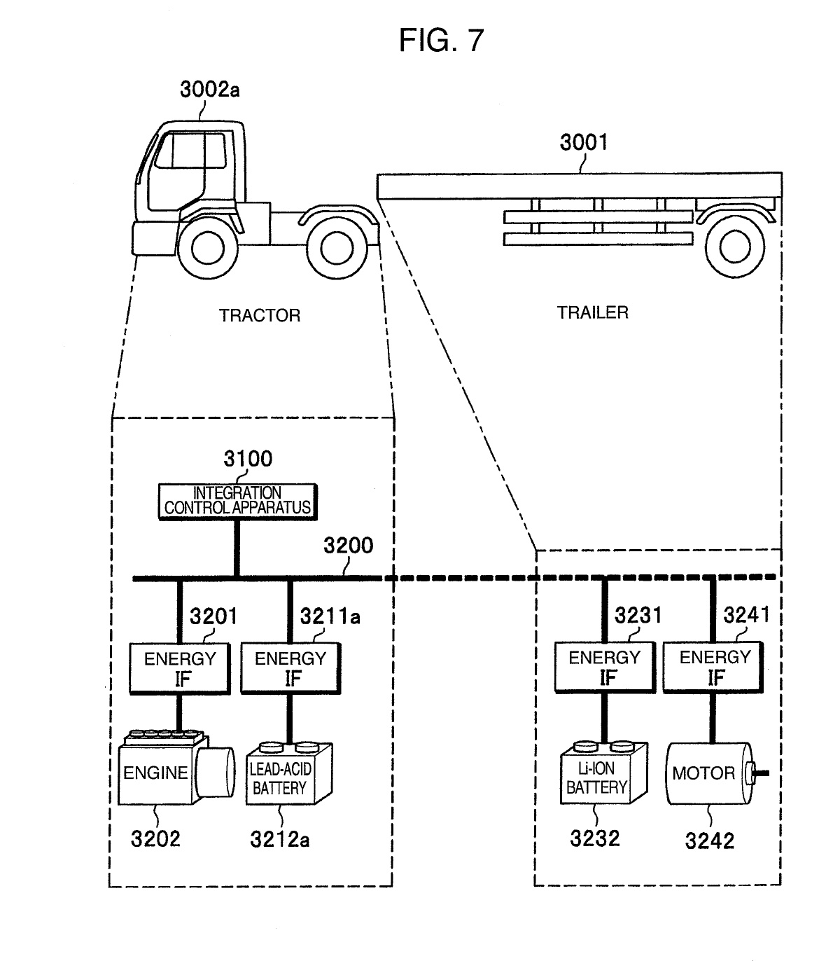

FIG. 7 is a diagram showing a second specific example of the energy optimizing control system used for the towed vehicle. FIG. 7 includes a partial change of FIG. 6, and the same component elements as those in FIG. 6 are designated by the same reference numerals, respectively.

As shown in FIG. 7, the tractor 3002a includes an integration control apparatus 3100 for energy optimizing control operation, an engine 3203 and a Pb (lead) cell 3212a used for starting the engine 3202. This tractor 3002a, therefore, is itself an engine vehicle driven only by the engine 3202. Also, the trailer 3001 has the same configuration as in FIG. 6 and includes the Lead-acid battery 3232 and the motor 3242.

Next, when the trailer 3001 is coupled to the tractor 3002a, the integration control apparatus 3100 detects that the Lead-acid battery 3232 and the motor 3242 have been connected as objects to be controlled, and by acquiring the control condition information from the energy IFs 3231, 3241 connected thereto, respectively, generates the integrated constraints and the integration evaluation function thereby to control the engine 3202, the Li-ion battery 3212a, the Lead-acid battery 3232 and the motor 3243 in integration fashion.

In an application of the invention to the energy optimizing control system of the towed vehicle, therefore, the tractor 3002a of the engine vehicle can be converted to a hybrid vehicle simply by coupling the trailer 3001 to the tractor 3002a.

### Specific Example 3

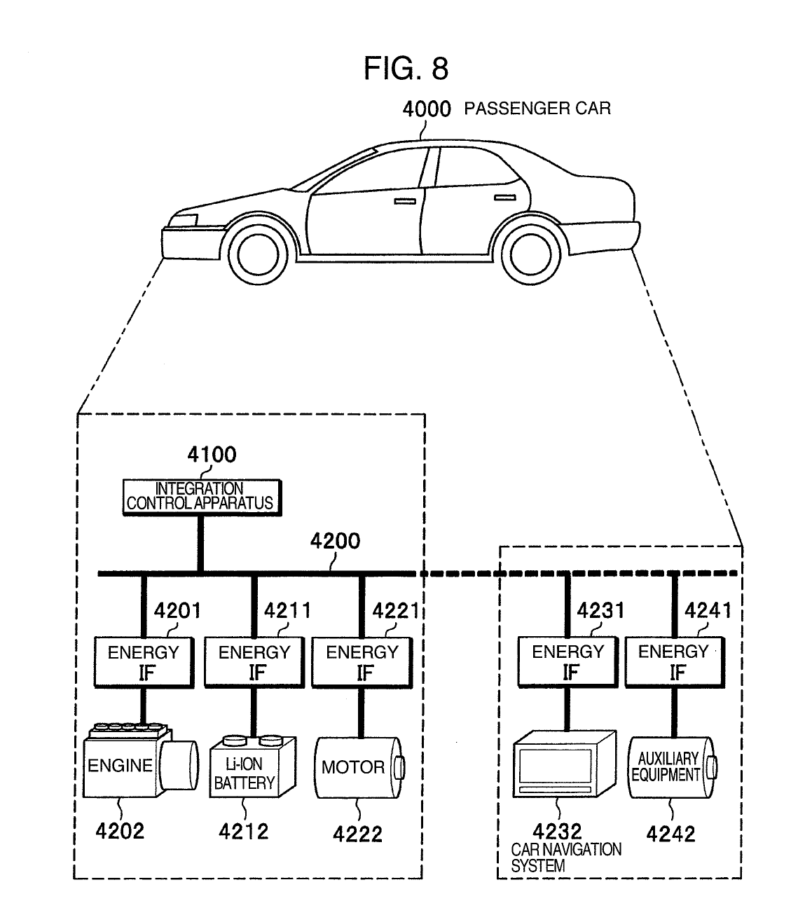

FIG. 8 is a diagram showing a specific example of the energy optimizing control system used for the passenger car. As shown in FIG. 8, the integration control apparatus 4100 on the passenger car 4000 is connected with an engine 4202, a Lead-acid battery 4212 and a motor 4222 through energy IFs 4201, 4211, 4221, respectively, and a network 4200. This passenger car 4000 is a hybrid car.

The engine 4202, the Lead-acid battery 4212 and the motor 4222 thus connected are normally subjected to the running control with minimum fuel consumption by the integration control apparatus 4100. Under this condition, assume that a car navigation system 4232 and an auxiliary equipment 4242 are connected to the integration control apparatus 4100 through the energy IFs 4231, 4241 and the network 4200. The integration control apparatus 4100 detects the connection, and by acquiring the control condition information from the energy IFs 4231, 4241, generates the integrated constraints and the integration evaluation function thereby to control the running car including the car navigation system 4232 and the auxiliary equipment 4242 to the minimum fuel consumption.

In the process, the information indicating that the car navigation system 4232 can be used as the environmental information acquisition unit 25 (FIG. 1), for example, is included in the attribute information of the control condition information of the energy IF 4231 for the car navigation system 4232. The integration control apparatus 4100, upon acquisition and detection of the control condition information, uses the car navigation system 4232 as the environmental information acquisition unit 25.

The car navigation system 4232 has the information on the congestion on the road leading to the destination, and the predicted required time to the destination based on the congestion information can be used as the environmental information. Also, the gradient information of the road along which the car is guided can be considered the important environmental information having a great effect on the running energy consumption. The energy optimizing control operation by the integration control apparatus 4100 taking these environmental information into consideration makes possible more detailed drive control with low fuel consumption.

### Specific Example 4

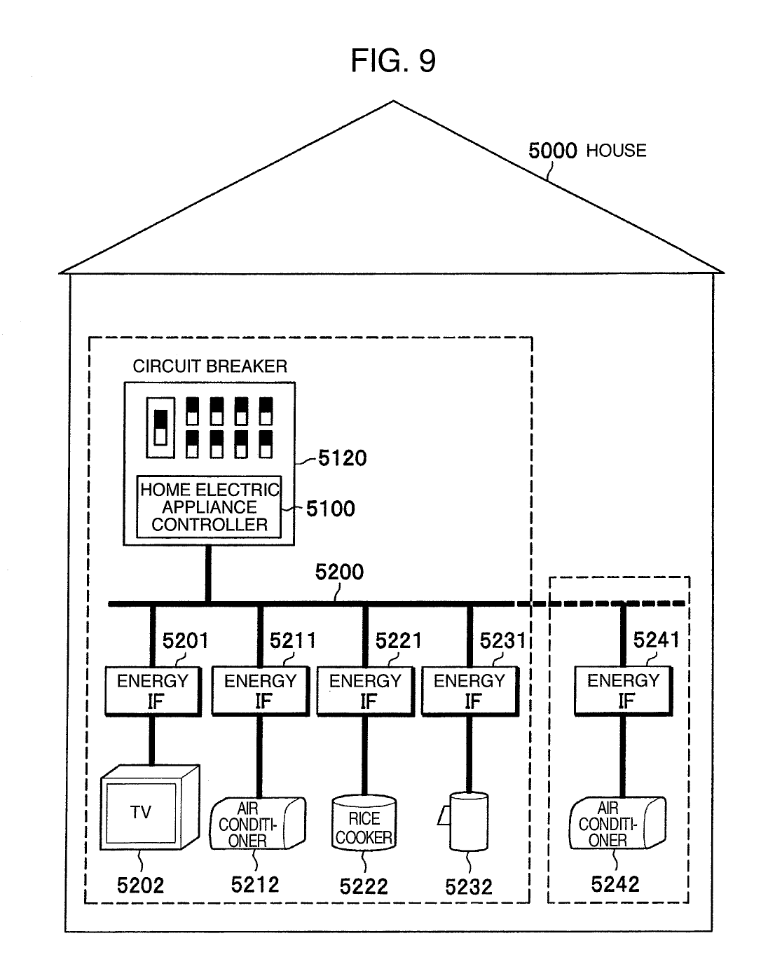

FIG. 9 is a diagram showing a specific example of the energy optimizing control system used for an ordinary house. As shown in FIG. 9, the house 5000 includes a home electric appliance controller 5100 functioning as an integration control apparatus connected with home electric appliances such as a TV 5202, an air conditioner 5212, an electric rice cooker 5222 and an electric water heater 5232 through energy IFs 5201, 5211, 5221, 5231, respectively, and a network 5200.

The home electric appliance controller 5100 is installed in association with a circuit breaker 5120, for example, to suppress the power consumption of the home electric appliances to be controlled, while at the same time controlling the operation of the home electric appliances in such a manner that the actual current consumption may not exceed the agreed wattage.

In the case where the rice cooker 5222, the water heater 5232 and the air conditioner 5212 are used at the same time, for example, the home electric appliance controller 5100 supplies power to the rice cooker 5222 in priority to make sure that the rice is cooked successfully, while limiting the power supply to the water heater 5223 and the air conditioner 5212 not to activate the circuit breaker 5120. This may result in a longer time to heat water or a change in room temperature, which poses no problem as far as the change remains unnoticed or in the range bearable by the user.

For the reason described above, the order of priority is preferably required to be predetermined for the home electric appliances freely by the user on the display panel or the like attached to the home electric appliance controller 5100. As an alternative, each of the home electric appliances may have a predetermined order of priority. In the latter case, the priority information is transmitted to the home electric appliance controller 5100 as a part of the attribute information of the control condition information 120 (FIG. 1), for example, whenever a particular home electric appliance is connected to the controller 5100.

The home electric appliance controller 5100 also can detect the addition or removal of a home electric appliance in the house 5000 any time through the energy IF. In the case where the air conditioner 5242 is newly added to the controller 5100, for example, the controller 5100 acquires the control condition information on the air conditioner 5242 from the energy IF 5241 for the air conditioner 5242 and thus can control the power supply for all the home electric appliances including the air conditioner.

Incidentally, the home electric appliance controller 5100 can be connected with energy supply equipment such as a photovoltaic generation system, a power storage unit or a water heat accumulator as well as the shown home electric appliances through energy IFs.

It should be further understood by those skilled in the art that although the foregoing description has been made on embodiments of the invention, the invention is not limited thereto and various changes and modifications may be made without departing from the spirit of the invention and the scope of the appended claims.

1. An optimizing control method for an optimizing control system including an integration control apparatus, at least a control information standardization interface, at least a local control apparatus and at least a local apparatus,
wherein the local control apparatus is connected to and controls the local apparatus,
wherein the integration control apparatus is connected to and controls, in integration fashion, a plurality of the local control apparatuses through the control information standardization interfaces arranged for the local control apparatuses, respectively,
wherein each control information standardization interface holds the control condition information including the constraints and the evaluation function expressed by a predetermined standard physical quantity for controlling each local apparatus and the attribute information indicating the feature of the control operation of the local apparatus,
wherein each control information standardization interface converts the local physical status amount output from each local control apparatus into the standard physical status amount expressed by the predetermined physical standard amount,
wherein the integration control apparatus calculates the optical setpoint for each local control apparatus based on the control condition information held by each control information standardization interface and the converted standard physical status amount,
wherein each control information standardization interface converts the optical setpoint for each local control apparatus calculated by the integration control apparatus into a local control goal value of a physical quantity corresponding to the local apparatus, and
wherein each control information standardization interface outputs the converted local control goal value to each local control apparatus.

2. The optimizing control method according to claim 1,
wherein the integration control apparatus calculates the optical setpoint for each local control apparatus in such a manner that the constraints and the evaluation function included in the control condition information held by each control information standardization interface are integration thereby to generate an integrated constraints and an integration evaluation function expressed by the standard physical quantity, and
wherein the optical setpoint for each local control apparatus is calculated using the integrated constraints and the integration evaluation function generated and the standard physical status amount output from each local control apparatus.

3. An optimizing control method for an optimizing control system including an integration control apparatus, at least a local control apparatus and at least a local apparatus,
wherein each local control apparatus is connected to and controls the local apparatus,
wherein the integration control apparatus is connected to and controls a plurality of the local control apparatuses in integration fashion,
wherein each local control apparatus holds the control condition information including the constraints and the evaluation function expressed by a predetermined standard physical quantity for controlling the local apparatus and the attribute information indicating the feature of the control operation of the local apparatus,
wherein the local physical status amount output from each local apparatus is converted into the standard physical status amount expressed by the predetermined physical standard amount,
wherein the integration control apparatus integrates the constraints and the evaluation function included in the control condition information held by each local control apparatus thereby to generate an integrated constraints and an integration evaluation function expressed by the standard physical quantity, and
wherein the optical setpoint for each local control apparatus is calculated using the integrated constraints and the integration evaluation function generated and the standard physical status amount output from each local control apparatus,
wherein the local control apparatus converts the optical setpoint for each local control apparatus calculated by the integration control apparatus into a local control goal value of a physical quantity corresponding to the local apparatus, and
wherein the local control goal value converted is output to the local apparatus.

4. The optimizing control method according to claim 3,
wherein the optimizing control system further includes a specified local control apparatus constituting the local control apparatus not executing the process of converting the local physical status amount output from the local apparatus into the standard physical status amount and the process of converting the optical setpoint calculated by the integration control apparatus into the local physical status amount, and
wherein the integration control apparatus converts the local physical status amount which may be input from the specified local control apparatus into the standard physical status amount, and
wherein the integration control apparatus converts the calculated optical setpoint which may be output to the specified local control apparatus into a local control goal value of a physical quantity corresponding to the specified local apparatus.

5. The optimizing control method according to claim 4,
wherein the optimizing control system further includes a second specified local control apparatus constituting the specified local control apparatus not holding the control condition information,
wherein the integration control apparatus holds the specified control condition information constituting the control condition information for controlling the local apparatus connected to the second specified local control apparatus, and
wherein the integration control apparatus generates the integrated constraints and the integration evaluation function in such a manner that the constraints and the evaluation function for the second specified local control apparatus are not acquired from the second specified local control apparatus but from the specified control condition information held by the integration control apparatus.

6. An optimizing control system including an integration control apparatus, at least a control information standardization interface, at least a local control apparatus and at least a local apparatus,
wherein the local control apparatus is connected to and controls the local apparatus,
wherein the integration control apparatus is connected to and controls, in integration fashion, a plurality of the local control apparatuses through the control information standardization interfaces arranged for the local control apparatuses, respectively,
wherein each control information standardization interface holds the control condition information including the constraints and the evaluation function expressed by a predetermined standard physical quantity for controlling the local apparatus and the attribute information indicating the feature of the control operation of the local apparatus,
wherein the local physical status amount output from the local control apparatus is converted into the standard physical status amount expressed by the predetermined physical standard amount,
wherein the integration control apparatus calculates the optical setpoint for each local control apparatus based on the control condition information held by each control information standardization interface and the converted standard physical status amount,
wherein each control information standardization interface converts the optical setpoint for each local control apparatus calculated by the integration control apparatus into a local control goal value of a physical quantity corresponding to the local apparatus, and
wherein the converted local control goal value is output to the local control apparatus.

7. The optimizing control system according to claim 6,
wherein the integration control apparatus calculates the optical setpoint for each local control apparatus in such a manner that the constraints and the evaluation function included in the control condition information held by each control information standardization interface are integration thereby to generate an integrated constraints and an integration evaluation function expressed by the standard physical quantity, and
wherein the optical setpoint for each local control apparatus is calculated using the integrated constraints and the integration evaluation function generated and the standard physical status amount output from each local control apparatus.

8. An optimizing control system including an integration control apparatus, at least a local control apparatus and at least a local apparatus,
wherein the local control apparatus is connected to and controls the local apparatus,
wherein the integration control apparatus is connected to and controls a plurality of the local control apparatuses in integration fashion,
wherein the local control apparatus holds the control condition information including the constraints and the evaluation function expressed by a predetermined standard physical quantity for controlling the local apparatus and the attribute information indicating the feature of the control operation of the local apparatus,
wherein the local physical status amount output from the local control apparatus is converted into the standard physical status amount expressed by the predetermined physical standard amount,
wherein the integration control apparatus integrates the constraints and the evaluation function included in the control condition information held by each local control apparatus thereby to generate an integrated constraints and an integration evaluation function expressed by the standard physical quantity,
wherein the optical setpoint for each local control apparatus is calculated using the integrated constraints and the integration evaluation function generated and the standard physical status amount output from each local control apparatus,
wherein the local control apparatus converts the optical setpoint for each local control apparatus calculated by the integration control apparatus into a local control goal value of a physical quantity corresponding to the local apparatus, and
wherein the local control goal value converted is output to the local apparatus.

9. The optimizing control system according to claim 8,
wherein the optimizing control system further includes a specified local control apparatus constituting the local control apparatus not executing the process of converting the local physical status amount output from the local apparatus into the standard physical status amount and the process of converting the optical setpoint calculated by the integration control apparatus into the local physical status amount, and
wherein the integration control apparatus converts the local physical status amount which may be input from the specified local control apparatus into the standard physical status amount, and
wherein the integration control apparatus converts the calculated optical setpoint which may be output to the specified local control apparatus into a local control goal value of a physical quantity corresponding to the specified local apparatus.

10. The optimizing control system according to claim 9, further comprising a second specified control apparatus constituting the specified local control apparatus not holding the control condition information,
wherein the integration control apparatus holds the specified control condition information constituting the control condition information for controlling the local apparatus connected to the second specified local control apparatus, and
wherein the integration control apparatus generates the integrated constraints and the integration evaluation function in such a manner that the constraints and the evaluation function for the second specified local control apparatus are not acquired from the second specified local control apparatus but from the specified control condition information held by the integration control apparatus.

11. An integration control apparatus for an optimizing control system including the integration control apparatus, at least a local control apparatus and at least a local apparatus,
wherein the local control apparatus is connected to and controls the local apparatus,
wherein the integration control apparatus is connected to and controls a plurality of the local control apparatuses in integration fashion,
wherein the integration control apparatus acquires, from each local control apparatus, the control condition information held by each local control apparatus and including the constraints and the evaluation function expressed by a predetermined standard physical quantity for controlling the local apparatus and the attribute information indicating the feature of the control operation of the local apparatus, and generates an integrated constraints and an integration evaluation function expressed by the standard physical quantity by integrating the constraints and the evaluation function included in each control condition information acquired, and
wherein the integration control apparatus calculates the optical setpoint for each local control apparatus using the integrated constraints and the integration evaluation function generated and the standard physical status amount output from each local control apparatus and outputs the calculated optical setpoint to each local control apparatus.

12. The integration control apparatus according to claim 11,
wherein the optimizing control system further includes a specified local control apparatus constituting the local control apparatus not executing the process of converting the local physical status amount output from the local apparatus into the standard physical status amount and the process of converting the optical setpoint calculated by the integration control apparatus into the local physical status amount, and
wherein the integration control apparatus converts the local physical status amount which may be input from the specified local control apparatus into the standard physical status amount, and
wherein the integration control apparatus converts the calculated optical setpoint which may be output to the specified local control apparatus into a local control goal value of a physical quantity corresponding to the specified local apparatus.

13. The integration control apparatus according to claim 12,
wherein the optimizing control system further includes a second specified control apparatus constituting the specified local control apparatus not holding the control condition information,
wherein the integration control apparatus holds the specified control condition information constituting the control condition information for controlling the local apparatus connected to the second specified local control apparatus, and
wherein the integration control apparatus generates the integrated constraints and the integration evaluation function in such a manner that the constraints and the evaluation function for the second specified local control apparatus are not acquired from the second specified local control apparatus but from the specified control condition information held by the integration control apparatus.

14. A local control apparatus used for an optimizing control system including an integration control apparatus, at least the local control apparatus and at least a local apparatus,
wherein the local control apparatus is connected to and controls the local apparatus,
wherein the integration control apparatus is connected to and controls a plurality of the local control apparatuses in integration fashion, and
wherein the local control apparatus holds the control condition information including the constraints and the evaluation function expressed by a predetermined standard physical quantity for controlling the local apparatus and the attribute information indicating the feature of the control operation of the local apparatus.

15. The local control apparatus according to claim 14,
wherein the local physical status amount acquired from the local apparatus is converted into a standard physical status amount expressed by the standard physical quantity, and the optical setpoint transmitted from the integration control apparatus is converted into a local control goal value of a physical quantity corresponding to the local apparatus.
